(19) United States
(12) Patent Application Publication
(10) Pub. No.: US 2026/0146906 A1
(43) Pub. Date: May 28, 2026

(54) BRAIN INJURY CRITERIA COMPONENT TEST

(71) Applicant: Toyota Motor Engineering & Manufacturing North America, Inc., Plano, TX (US)

(72) Inventors: Valerie Schnabelrauch, Ypsilanti, MI (US); David Vella, Whitmore Lake, MI (US); Todd P. Lang, Plymouth, MI (US); Naipaul Deo Ramoutar, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/956,124

(22) Filed: Nov. 22, 2024

(51) Int. Cl. G01L 5/00; G09B 23/32

(52) U.S. Cl. CPC G01L 5/0052; G09B 23/32

(57) ABSTRACT

A system for component testing for head or brain injury criteria can include a vehicle seat that is substantially stationary. A dummy can be seated in the vehicle seat. The dummy can include a head and a body. An impactor can be substantially aligned with the head. An airbag can be located between the dummy and the impactor. The impactor can be caused to be projected toward a head of a dummy at a target energy, a target position, and/or with a target stroke.

### FIELD

The subject matter described herein relates in general to vehicle occupant safety and, more particularly, to testing for vehicle occupant safety.

### BACKGROUND

Brain injury criteria is a measure of the likelihood of brain injury arising from an impact. Brain injury criteria can be used to assess safety related to vehicles and vehicle restraints. A relatively new metric and subset of brain injury criteria is brain rotational injury criteria. In some crash situations, the skull may rotate around the brain and cause injury.

### SUMMARY

In one respect, the present disclosure is directed to a method. The method includes causing an impactor to be projected toward a head of a dummy at a target speed and a target position. The dummy can be in a seated position on a vehicle seat. An airbag can be located between the head and the impactor. The vehicle seat can be substantially stationary.

In another respect, the present disclosure is directed to a system. The system includes a vehicle seat. The vehicle seat can be substantially stationary. The system can include a dummy seated in the vehicle seat. The dummy can include a head and a body. The system can include an impactor substantially aligned with the head. The impactor can be configured to be projected toward the head. The system can include an airbag located between the dummy and the impactor.

### BRIEF DESCRIPTION OF THE DRAWINGS

FIG. 1 is an example of a testing environment, showing a view from an exterior of a vehicle body.

FIG. 2 is an example of the testing environment of FIG. 1, showing a view from an interior of the vehicle body.

FIG. 3 is an example of the testing environment, showing a plan view.

FIG. 4 is an example of a system.

FIG. 5 is an example of a method.

FIG. 6A is an example of a test at a first moment in time, showing a view from an exterior of a vehicle body.

FIG. 6B is an example of the test at the first moment in time, showing a view from an interior of the vehicle body.

FIG. 7A is an example of the test at a second moment in time, showing a view from the exterior of the vehicle body.

FIG. 7B is an example of the test at the second moment in time, showing a view from the interior of the vehicle body.

FIG. 8A is an example of the test at a third moment in time, showing a view from the exterior of the vehicle body.

FIG. 8B is an example of the test at the third moment in time, showing a view from the interior of the vehicle body.

### DETAILED DESCRIPTION

Brain rotational injury criteria can be developed by vehicle testing or by component testing. Component testing can be used to assist in the develop of a vehicle occupant restraint (e.g., an airbag) at least from a brain rotational injury criteria standpoint. Component testing can be used to replicate the vehicle test. One component test method for brain rotational injury criteria development involves using a sled fixture to accelerate a dummy head into a side curtain airbag.

However, such component testing can have some downsides. For instance, only a dummy head is used. Consequently, there is no interaction between a full dummy and a vehicle seat. Thus, the test is less likely to match real-world conditions. Further, honeycomb structures are used, but they need to be tuned to match vehicle deceleration. Still further, current component testing results in vehicle/body destruction. For instance, the floor is cut to install the fixturing. As a result, a seat cannot be installed, and the opposite side B-pillar is removed. As a result of these modifications, it does not allow any other test use on the vehicle.

Accordingly, arrangements described herein are directed to enabling head or brain injury criteria development through physical component testing. For example, arrangements described herein can replicate through physical component testing a side impact rigid pole test.

Arrangements described herein include causing an impactor to be projected toward a head of a dummy. The impactor can be projected at a target energy (e.g., at a target speed and/or with a target mass), a target position, and/or with a target stroke. The dummy can be in a seated position on a vehicle seat. An airbag can be located between the head and the impactor. The vehicle seat can be substantially stationary. Such testing can yield sensor data comparable to what can be obtained in typical vehicle testing without causing any destruction of the vehicle. Such arrangements can facilitate the development of a restraint system for this injury metric in a component set-up without needing to crash a vehicle or cut a vehicle for fixturing.

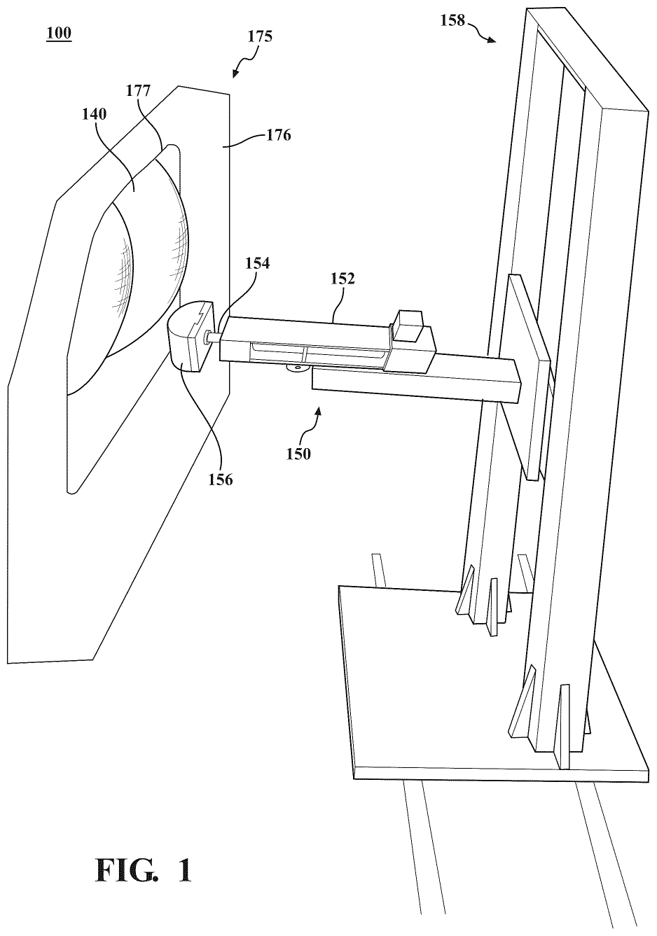

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIGS. 1-3 show an example of a testing environment 100. Referring to FIG. 1, a view of the testing environment 100 from an exterior of a vehicle body 175 is shown. The testing environment 100 can include the vehicle body 175 and an impactor 150. The vehicle body 175 can be an entire vehicle or any subset thereof, including at any stage of assembly or disassembly. Here, the vehicle body 175 is represented by a door 176 defining a window opening 177. The window can be in a down position, removed, or not installed.

An airbag 140 can be associated with the vehicle body 175. The airbag 140 can be a side curtain airbag. The airbag 140 is shown in a deployed state. The airbag 140 can be located on a cabin side of the vehicle body 175. In some instances, a portion of the airbag 140 can extend into the window opening 177.

The impactor 150 can be positioned toward the window opening 177. The impactor 150 can include a pole 154 and an end member 156. The end member 156 can be configured to mimic a component being crashed into a vehicle during an actual crash test.

The impactor 150 can be operatively connected to a launcher 152. The launcher 152 can be configured to project the pole 154 and the end member 156 toward the window opening 177 at a target energy (e.g., at a target speed and/or with a target mass), a target position, and/or with a target stroke.

The impactor 150 can be operatively connected to a fixture 158. The impactor 150 can be moved in a vertical direction and/or within a horizontal plane on the fixture 158. The impactor 150 can be moved manually or automatically.

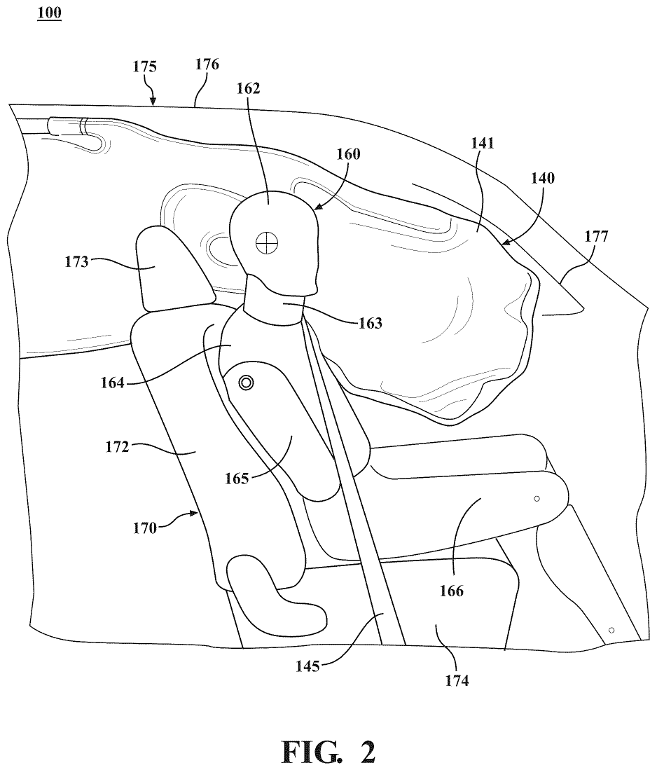

FIG. 2 shows the testing environment 100 viewed from an interior of the vehicle body 175. The testing environment 100 can include a vehicle seat 170. The vehicle seat 170 can be substantially stationary during the testing. The vehicle seat 170 can include a back portion 172 and a seat portion 174. In some instances, the vehicle seat 170 can include a headrest 173.

A dummy 160 can be seated in the vehicle seat 170. The dummy can include a head 162, a neck 163, and a torso 164. The dummy 160 can include other body parts, such as one or more arms 165, one or more legs 166, etc. The dummy 160 can be poisoned to be as close to the position of a dummy in a vehicle test as possible.

In some arrangements, the dummy 160 can be retrained in the vehicle seat 170 by one or more retraining structures, such as a seat belt 145. The dummy 160 can be instrumented with a plurality of sensors, such as accelerometers, multi-axis load cells, and angular rate sensors. These sensors can be configured to acquire data or information pertinent to head injury criteria, brain injury criteria, or brain rotational injury criteria. The sensors can be configured to acquired data or information about movement of the dummy during the test and, more particularly, head movement. More particularly, the sensors can be configured to acquire data or information about head acceleration, head rotation, neck lower force, neck lower moment, neck upper force, neck upper moment, spine T1 acceleration, impactor/vehicle acceleration, and side curtain airbag fire time.

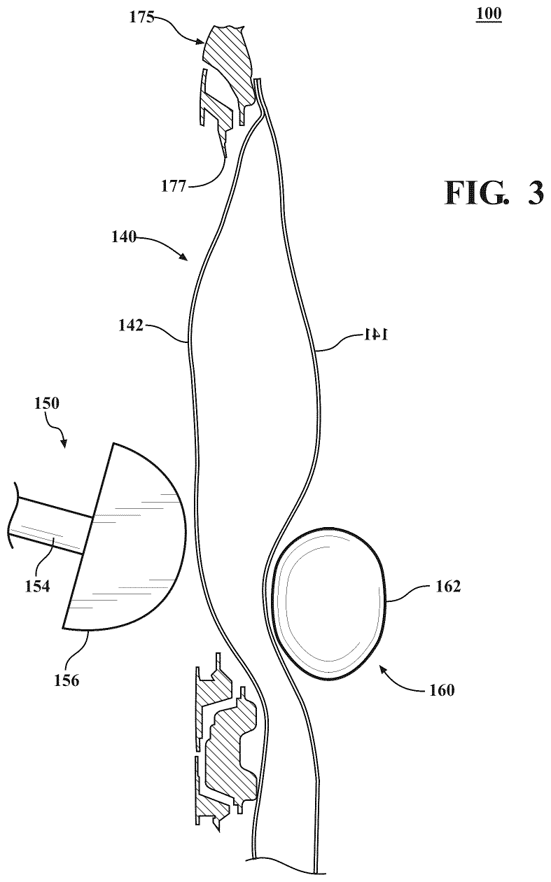

Referring to FIG. 3, a top view of the testing environment 100 is shown. The airbag 140 can be located between the impactor 150 and the dummy 160. The airbag 140 can have an inner surface 141 and an outer surface 142. The impactor 150 can be substantially aligned with the head 162 of the dummy 160. When projected, the impactor 150 can move substantially linearly within a substantially horizontal plane. However, in some arrangements, the impactor 150 can move substantially linearly within a three dimensional space.

The impactor 150 can be sized, shaped, configured, and/or positioned to pass through the window opening 177 when projected. The impactor 150 can be configured to be projected at the head 162 at a target energy (e.g., at a target speed and/or with a target mass), a target position, and/or with a target stroke. It should be noted that, in some arrangements, the head 162 of the dummy 160 can be tilted into the deployed airbag 140. Such positioning can simulate vehicle crash test observations of the head 162 tilting into the airbag 140 during a crash test.

In this way, a component test (e.g., a test of the airbag) can be performed. The component test can simulate a vehicle crash test. The impactor is projected at the occupant's head at the speed and position representing the vehicle test while deploying the vehicle restraint system. The injury metrics are measured from the exact dummy instrumentation as in the vehicle test.

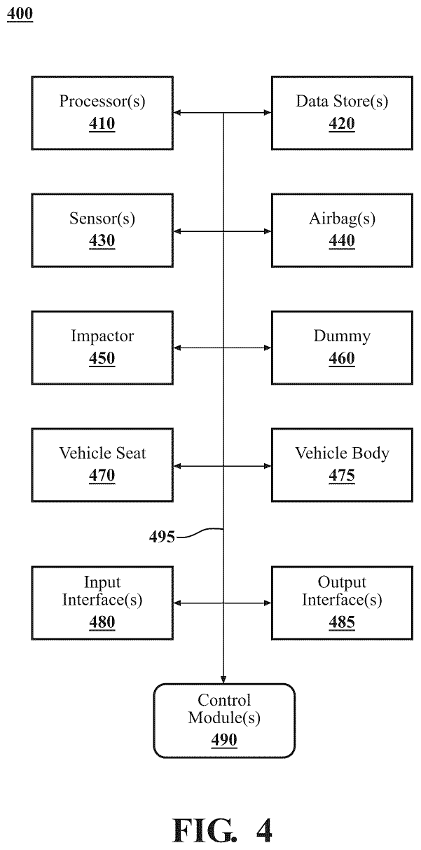

Referring to FIG. 4, an example of a system 400 is shown. The system 400 can allow for head, brain, and/or brain rotational injury criteria development through physical component testing. The component test can simulate a vehicle crash test.

The system 400 can include various elements. Some of the possible elements of the system 400 are shown in FIG. 4 and will now be described. It will be understood that it is not necessary for the system 400 to have all of the elements shown in FIG. 4 or described herein. The system 400 can have any combination of the various elements shown in FIG. 4. Further, the system 400 can have additional elements to those shown in FIG. 4. In some arrangements, the system 400 may not include one or more of the elements shown in FIG. 4.

In the context of a vehicle, the various elements of the system 400 may be located in a testing environment; however, it will be understood that one or more of these elements can be located external to the testing environment. Further, the elements shown may be physically separated by large distances. Indeed, one or more of the elements can be located remote from the vehicle, such an on a remote server or cloud-based server.

The system 400 can include one or more processors 410, one or more data stores 420, one or more sensors 430, one or more airbags 440, an impactor 450, a dummy 460, a vehicle seat 470, a vehicle body 475, one or more input interfaces 480, one or more output interfaces 485, and/or one or more control modules 490. The various potential elements of the system 400 will be described in turn below.

The various elements of the system 400 can be communicatively linked to one another or one or more other elements through one or more communication networks 495. As used herein, the term “communicatively linked” can include direct or indirect connections through a communication channel, bus, pathway or another component or system. A “communication network” means one or more components designed to transmit and/or receive information from one source to another. The data store(s) 420 and/or one or more other elements of the system 400 can include and/or execute suitable communication software, which enables the various elements to communicate with each other through the communication network and perform the functions disclosed herein.

The one or more communication networks can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

As noted above, the system 400 can include one or more processors 410. “Processor” means any component or group of components that are configured to execute any of the processes described herein or any form of instructions to carry out such processes or cause such processes to be performed. The processor(s) 410 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 410 can include at least one hardware circuit (e.g., an integrated circuit) configured to carry out instructions contained in program code. In arrangements in which there is a plurality of processors 410, such processors can work independently from each other or one or more processors can work in combination with each other.

The system 400 can include one or more data stores 420 for storing one or more types of data. The data store(s) 420 can include volatile and/or non-volatile memory. Examples of suitable data stores 420 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 420 can be a component of the processor(s) 410, or the data store(s) 420 can be operatively connected to the processor(s) 410 for use thereby. The term “operatively connected,” as used throughout this description, can include direct or indirect connections, including connections without direct physical contact.

The data store(s) 420 can include historic data acquired by the sensor(s) 430. The data store(s) 420 can include head, brain, and/or brain rotational injury criteria information or standards. One example of a relevant standard is the U.S. Department of Transportation, National Highway Traffic Safety Administration, “Laboratory Test Procedure for the New Car Assessment Program Side Impact Moving Deformable Barrier Test.” Another example of a relevant standard is the U.S. Department of Transportation, National Highway Traffic Safety Administration, “Laboratory Test Procedure for the New Car Assessment Program Side Impact Rigid Pole Test.”

The system 400 can include one or more sensors 430. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 400 includes a plurality of sensors 430, the sensors can work independently from each other. Alternatively, two or more of the sensors can work in combination with each other. In such case, the two or more sensors can form a sensor network. The sensor(s) 430 can be operatively connected to the processor(s) 410, the data store(s) 420, and/or other elements of the system 400 (including any of the elements shown in FIG. 4).

The sensor(s) 430 can include any suitable type of sensor. Various examples of different types of sensors will be described herein. However, it will be understood that the embodiments are not limited to the particular sensors described.

The sensor(s) 430 can be used in any suitable location within the system 400. For instance, the sensor(s) 430 can be used on the dummy 460, the impactor 450, the airbag(s) 440, the vehicle body 475, and/or in any other location. In some instances, the sensor(s) 430 can be used in connection with one or more of the elements of the system 400 but are located remote from that element. For instance, the sensor(s) 430 can include one or more cameras that are operatively positioned to capture visual data about the dummy 460. As an example, the visual data can be used to detect motion of the head 462, such as by tracking the movement of target points on the dummy 460.

One or more sensors 430 can be used on the head 462 of the dummy 460 and one or more sensors 430 can be used on the neck 463 of the dummy 460. In one or more arrangements, the sensors 430 can include a plurality of accelerometers, a plurality of angular rate sensor, and a plurality of 6-axis load cells. For instance, the plurality of accelerometers and the plurality of angular rate sensors can be used on the head 462 of the dummy 460, and the plurality of 6-axis load cells can be used on the neck 463 of the dummy 460. Sensor data acquired by the angular rate sensors can be used to develop brain injury rotational criteria. In one or more arrangements, a plurality of accelerometers can be used in connection with the impactor 450. Sensor data from the accelerometers can be used to detect velocity and/or displacement of the impactor 450. In some arrangements, the sensors 430 can be configured to acquire data or information about head acceleration, head rotation, neck lower force, neck lower moment, neck upper force, neck upper moment, spine T1 acceleration, impactor/vehicle acceleration, and side curtain airbag fire time.

The system 400 can include one or more airbags 440 or other occupant protection device. The airbag 140 in FIGS. 1-3 corresponds to the airbag(s) 440 here. The airbag(s) 440 can provide a vehicle occupant with soft cushioning and restraint during a collision. The airbag(s) 440 can be operatively positioned between the dummy 460 (e.g., the head of the dummy) and the impactor 450. The airbag(s) 440 can be any type of airbag, now known or later developed.

In one or more arrangements, the airbag(s) 440 can be a side curtain airbag or other type of airbag that provides occupant protection against lateral impacts. The side curtain airbag can be any type of side curtain airbag, now known or later developed. The airbag(s) 440 can have any suitable configuration.

In some arrangements, the airbag(s) 440 can be selectively deployable. In some arrangements, the airbag(s) 440 can deploy from a roof line above a side window to provide cushioning between an occupant's head and the window or an incoming objects. The airbag(s) 440 can be configured to inflate in milliseconds and then deflate afterwards.

In some arrangements, the airbag(s) 440 can be inflated in a non-live first deployment manner. In such case, the airbag(s) 440 can be inflated prior to causing the impactor 450 to be projected toward the head 462 of the dummy 460. In some arrangements, the airbag(s) 440 can be inflated using a pressurized fluid (e.g., air) within the testing environment. As an example, the airbag(s) 440 can be inflated using shop air.

In some arrangements, the airbag(s) 440 can have a passenger facing side and an outboard side. In some arrangements, the cabin facing side can be substantially flat when inflated. In other arrangements, the passenger facing side can be substantially non-flat when inflated. The airbag(s) 440 can have one or more chambers to achieve a desired inflated configuration. For instance, different chambers may inflate differently for clearance with structures within the vehicle. However, due to the shape of the cabin facing side during impact, a rotation can be imparted onto the head 462 of the dummy 460 when it comes into contact with the airbag(s) 440.

It will be appreciated that, according to arrangements described herein, the airbag(s) 440 can be tested to assess how the airbag(s) 440 may affect the movement and/or rotation of the head 462 of the dummy 460. For instance, it can be assessed how the head 462 of the dummy 460 rotates as the airbag(s) 440 is getting pushed into it by impactor 450. Based on the sensor data acquired during testing, the configuration of the airbag(s) 440 (e.g., the locations, inflated configuration, location of different chambers, etc.) can be tuned to reduce head, brain, or brain rotational injuries.

The system 400 can include an impactor 450. The impactor 150 in FIGS. 1 and 3 corresponds to the impactor 450 here. The impactor 450 can be any type of impactor, now known or later developed. The impactor 450 can include a launcher (see, e.g., launcher 152 in FIG. 2), a pole 454, and an end member 456. The impactor 450 can be mounted on a fixture (see, e.g., fixture 158 in FIG. 1) to enable vertical and/or horizontal positioning of the impactor 450. One non-limiting example of such elements is the Linear Impact System available from MGA Research Corporation, Akron, New York.

The pole 454 can be at least partially received in the launcher. The launcher can be configured to project the pole 454 away from the launcher at a target speed. In some arrangements, the launcher can project the pole 454 linearly. In some arrangements, the launcher can use air, nitrogen, or other gas to propel the impactor 450. In some arrangements, the impactor 450 can be projected with a target stroke (e.g., a fixed stroke), which can help to substantially replicate the vehicle test condition.

The end member 456 can be operatively connected to the pole 454. The end member 456 can be readily replaced with a different end member. The end member 456 can have any suitable mass, size, shape, and/or configuration. In one or more arrangements, the end member 456 and the pole 454 can be sized, shaped, and/or configured to pass through a window opening 477 of the vehicle body 475 without engaging the vehicle body 475.

The end member 456 can substantially simulate a structure that comes into contact with the vehicle body 475 during a vehicle crash test. In one or more arrangements, the end member 456 can simulate a pole. In such case, the end member 456 can be substantially cylindrical or substantially semi-cylindrical. The end member 456 can simulate the radius of a pole used in a vehicle crash test. In one or more arrangements, the end member 456 can have a radius of about 5 inches or a diameter of about 10 inches. The size of the end member 456 can be determined by, for example, an appropriate testing standard.

The end member 456 can be made in any suitable manner, such as by three dimensional printing. The end member 456 can be made of any suitable material, such as polyethylene terephthalate (PET). The material of the end member can be selected so that the mass is sufficiently low to obtain the desired speed and energy.

The end member 456 can be readily connected and disconnected from the pole 454. Thus, the end member 456 can be readily replaced with a different end member.

The system 400 can include a dummy 460. The dummy 160 in FIGS. 2-3 corresponds to the dummy 460 here. The dummy 460 can be any type of dummy, now known or later developed. The dummy 460 can be a full-scale anthropomorphic test device. The dummy 460 can be configured to simulate the dimensions, weight proportions, and/or articulation of a human body during a vehicle crash or collision.

The dummy 460 can represent a full human body or a portion of a full human body. The dummy 460 can include various body parts. For instance, the dummy 460 can include a head 462, a neck 463, a torso 464, and one or more arms. In some arrangements, the dummy 460 can include one or more legs. The dummy 460 can be instrumented with one or more of the sensor(s) 430 to collect sensor data or information pertinent to head injury criteria, brain injury criteria, or brain rotational injury criteria.

The system can include a vehicle seat 470. The vehicle seat 170 in FIG. 2 corresponds to the vehicle seat 470 here. The vehicle seat 170 can be any type of vehicle seat, now known or later developed. The vehicle seat 170 can be for any vehicle occupants, such for a driver and/or for a passenger. As used herein, “vehicle” means any form of transport, including motorized or powered transport. In one or more implementations, the vehicle can be an automobile. While arrangements will be described herein with respect to automobiles, it will be understood that embodiments are not limited to automobiles. In some implementations, the vehicle may be a watercraft, an aircraft, spacecraft, or any other form of powered transport.

The vehicle seat 470 can be an actual vehicle seat. In some arrangements, the vehicle seat 470 can be movable within the vehicle body 475 just as it would be in an actual vehicle.

The vehicle seat 470 can have any suitable configuration. For instance, the vehicle seat 470 can include a back portion and a seat portion (see, e.g., FIG. 2). In some arrangements, the back portion of the vehicle seat 470 can be configured to recline. The back portion can be reclined at any suitable angle when testing according to arrangements described herein.

In some arrangements, the vehicle seat 470 can include one or more bolsters, one or more arm rests, and/or a headrest. In some arrangements, the vehicle seat 470 can be a driver's seat. In other arrangements, the vehicle seat 470 can be a front passenger seat, a rear seat, or a middle seat.

The dummy 460 can be positioned on the vehicle seat 470. In some arrangements, the dummy 460 can be restrained on the vehicle seat 470. For instance, the dummy 460 can be restrained on the vehicle seat 470 by a seat belt 445. Alternatively or additionally, the dummy 460 can be restrained on the vehicle seat 470 by ratchet straps or other restraining devices.

Such retraining can help to match an actual vehicle test more closely and/or it can help to keep the dummy 460 in position on the vehicle seat 470. In a vehicle test, during the crash, the dummy moves toward the side curtain airbag or the side curtain airbag moves toward the dummy. In some arrangements, the dummy 460 can be tilted outboard on the vehicle seat 470 to match real-world conditions more closely.

The system can include a vehicle body 475. The vehicle body 475 in FIGS. 1-3 corresponds to the vehicle body 475 here. In some arrangements, the vehicle body 475 can be an entire vehicle. In other arrangements, the vehicle body 475 can be a portion of a vehicle, such as a half of a vehicle (e.g., front half, back half, driver side, or passenger side) or a quarter of a vehicle (e.g., driver side front, passenger side front, driver side back, or passenger side back).

The vehicle body 475 can be at any stage of assembly or disassembly. For instance, the vehicle body 475 can be a fully assembled vehicle, a unibody, a frame, a body in white, or a body in black, just to name a few possibilities. In some arrangements, the vehicle body 475 can include a window opening, a door, a floor, one or more pillars (e.g., an A-pillar), a hood, a roof, fenders, or any combination or subset thereof. In some arrangements, the vehicle body 475 can include a window. In other arrangements, the vehicle body 475 does not include a window.

The vehicle body 475 can be of a particular vehicle, a generic vehicle, or a representative vehicle that generally matches the size and shape of a vehicle of interest. The vehicle body 475 can define at least a portion of a passenger compartment. The vehicle seat 470 and the dummy 460 can be located in the passenger compartment.

The system 400 can include one or more input interfaces 480. An “input interface” includes any device, component, system, element or arrangement or groups thereof that enable information/data to be entered into a machine. The input interface(s) 480 can receive an input from a person or other entity. Any suitable input interface 480 can be used, including, for example, a keypad, display, touch screen, multi-touch screen, button, joystick, mouse, trackball, microphone, gesture recognition (radar, lidar, camera, or ultrasound-based), and/or combinations thereof.

The system 400 can include one or more output interfaces 485. An “output interface” includes any device, component, system, element or arrangement or groups thereof that enable information/data to be presented to a user (e.g., a person) or other entity. The output interface(s) 485 can present information/data to a user or other entity. The output interface(s) 485 can include a display, an earphone, haptic device, and/or speaker. Some components of the system 400 may serve as both a component of the input interface(s) 480 and a component of the output interface(s) 485.

The system 400 can include one or more modules, at least some of which will be described herein. The modules can be implemented as computer readable program code that, when executed by a processor, implement one or more of the various processes described herein. One or more of the modules can be a component of the processor(s) 410, or one or more of the modules can be executed on and/or distributed among other processing systems to which the processor(s) 410 is operatively connected. The modules can include instructions (e.g., program logic) executable by one or more processor(s) 410. Alternatively or in addition, one or more data stores 420 may contain such instructions.

The system 400 can include one or more modules. In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 400 can include one or more control modules 490. The control module(s) 490 can include profiles and logic for controlling one or more of the elements of the system 400. The control module(s) 490 can be configured to send control signals or commands over a communication network to one or more elements of the system 400.

For instance, the control module(s) 490 can be configured to cause the impactor 450 to be projected toward the head 462 of the dummy 460 at a target speed, a target position, and/or a target stroke. The control module(s) 490 can be configured to do so in any suitable manner. For instance, the control module(s) 490 can be configured to detect inputs (e.g., commands) provided on the input interface(s) 480. The command can be to launch the impactor 450, including at a target speed and/or a target position. Alternatively or additionally, the control module(s) 490 can activate the impactor 450 based on a program.

As used herein, “cause” or “causing” means to make, force, compel, direct, command, instruct, and/or enable an event or action to occur or at least be in a state where such event or action may occur, either in a direct or indirect manner. For instance, the control module(s) 490 can be configured to send control signals or commands over a communication network to the impactor 450 and/or other element of the system 400.

In some arrangements, the control module(s) 490 can be configured to set or adjust a position of the impactor. For instance, the control module(s) 490 can be configured to cause the vertical position and/or the horizontal orientation of the impactor 450 to be changed. The control module(s) 490 can be configured to cause the position of the impactor 450 relative to the head 462 to be set and/or adjusted. The control module(s) 490 can send control signals or commands to the impactor 450 and/or a fixture to which the impactor 450 is attached. In such case, the impactor 450 and/or the fixture can adjust the position and/or orientation of the impactor 450 by activating one or more actuators.

The control module(s) 490 can be configured to set and/or adjust the speed at which the impactor 450 is projected toward the head 462. The control module(s) 490 can send control signals or commands to the impactor 450 to fire at a particular speed. Such control signals or command can be determined automatically by the control module(s) 490, or they can be based on a user input provided on the input interface(s) 480.

As another example, the control module(s) can be configured to cause the airbag(s) 440 to be deployed. The control module(s) 490 can be configured to do so in any suitable manner. For instance, the control module(s) 490 can be configured to detect inputs (e.g., commands to activate the airbag(s) 440) provided on the input interface(s) 480. Alternatively or additionally, the control module(s) 490 can activate the airbag(s) 440 in response to or substantially simultaneously with the projecting of the impactor 450.

The control module(s) 490 can be configured to analyze data or information acquired by the sensor(s) 430. Alternatively or additionally, the control module(s) 490 can be configured to detect inputs (e.g., commands) provided on the input interface(s) 480. The control module(s) 490 can retrieve raw data from the sensor(s) 430 and/or from the data store(s) 420. The control module(s) 490 can use profiles, parameters, or setting loaded into the control module(s) 490 and/or stored in the data store(s) 420.

In some arrangements, the control module(s) 490 can analyze the sensor data to determine appropriate changes to the shape, configuration, location of chambers, and/or morphology of the airbag(s) 440. These changes can be output to a user for further consideration.

Now that the various potential systems, devices, elements and/or components of the testing environment 100 and the system 400 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

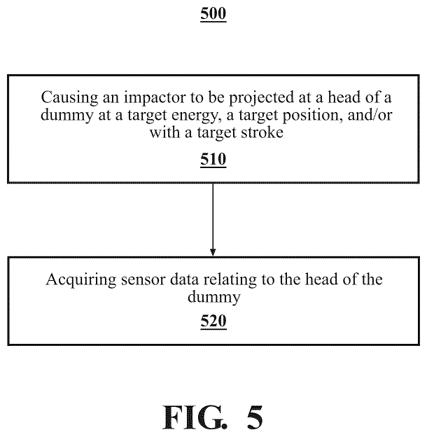

Turning to FIG. 5, an example of a method 500 is shown. For the sake of discussion, the method 500 can begin the dummy 460 located in the vehicle seat 470. The vehicle seat 470 can be located within a vehicle body 475. The impactor 450 can be substantially aligned with the head 462. The impactor 450 can be in a non-activated state where it has not been projected toward the head. An airbag 440 can be located between the dummy 460 and the impactor 450.

At block 510, the impactor 450 can be caused to be projected at the head 462 of the dummy 460 at a target energy, a target position, and/or with a target stroke. For instance, in one or more arrangements, the impactor 450 can be caused to be projected at the head 462 of the dummy 460 at a target energy and at a target position. Such causing can be performed by the control module(s) 490 and/or the processor(s) 410. The control module(s) 490 and/or the processor(s) 410 can send signals or commands to the impactor 450. In one or more arrangements, the causing can be performed in response to a user input or command to activate the impactor 450. The user input or command can be provided via the input interface(s) 480. The method 500 can continue to block 520.

At block 520, sensor data relating to the head of the dummy 460 can be acquired. Such acquiring can be performed by the sensor(s) 430 and/or the processor(s) 410. The sensor data can be acquired before, during, and/or after engagement between the impactor 450 and the airbag 440. The sensor data can include head rotation data, head angular rate data, head movement data, head acceleration data, head displacement data, and/or head velocity data. The acquired sensor data can be stored in the data store(s) 420.

The method 500 can end. Alternatively, the method 500 can return to block 510 or some other block. The method 500 can be repeated at any suitable point, such as at a suitable time or upon the occurrence of any suitable event or condition. Further, the method 500 can include alternative and/or additional blocks to those shown in FIG. 5. For instance, the method 500 can include causing the airbag 440 to be deployed while the impactor 450 is moving toward the head 462 of the dummy 460. Such causing can be performed by the control module(s) 490 and/or the processor(s) 410. As another example, the method 500 can include deploying the airbag 440 prior to causing the impactor 450 to be projected at the head 462 of a dummy 460.

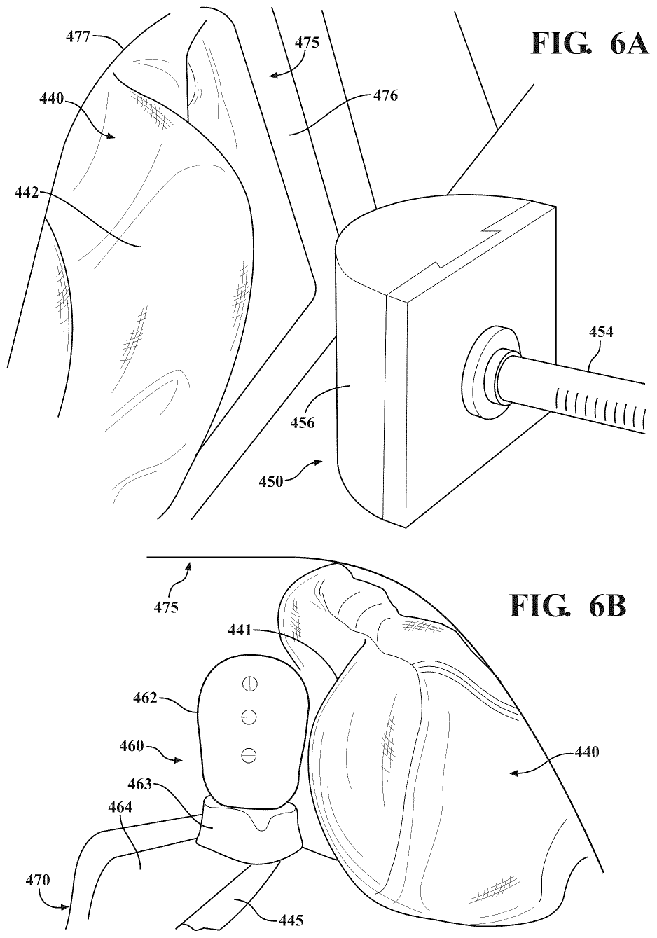

A non-limiting example of the operation of the arrangements described herein will now be presented in connection to FIGS. 6-8. For purposes of this example, the dummy 460 is seated in a vehicle seat 470. The impactor 450 is positioned substantially in line with the head 462 of the dummy. The impactor is at substantially the same vertical position as the head 462. The impactor 450 can be arranged in a target position relative to the head 462. In this example, the airbag 440 (e.g., a side curtain airbag) is already deployed. The airbag 440 can be located between the dummy 460 and the impactor 450. The dummy 460 can be instrumented with a plurality of sensors 430. Some sensors 430 can be located on the head 462 and/or the neck 463 of the dummy 460. The vehicle body 475 includes a door 476 defining a window opening 477. The window can be in a down position, removed, or not installed.

FIGS. 6A-6B show an example of a test at a first moment in time. At the first moment, the impactor 450 either has not been projected, or the impactor 450 has been projected but has not yet come into contact with the airbag 440. FIG. 6A shows a view from an exterior of a vehicle body 475, and FIG. 6B shows a view from an interior of the vehicle body 475. As can be seen, the end member 456 is spaced from the airbag 440. The head 462 of the dummy 460 can be in a neutral or initial position.

The airbag 440 can include an inner surface 441 and an outer surface 442. The head 462 can be slightly spaced from an inner surface 441 of the airbag 440. The inner surface 441 corresponding to an occupant facing side or a cabin facing side of the airbag 440. As is shown in FIG. 6B, the inner surface 441 of the airbag 440 is non-flat. Head data can be collected by the sensor(s) 430.

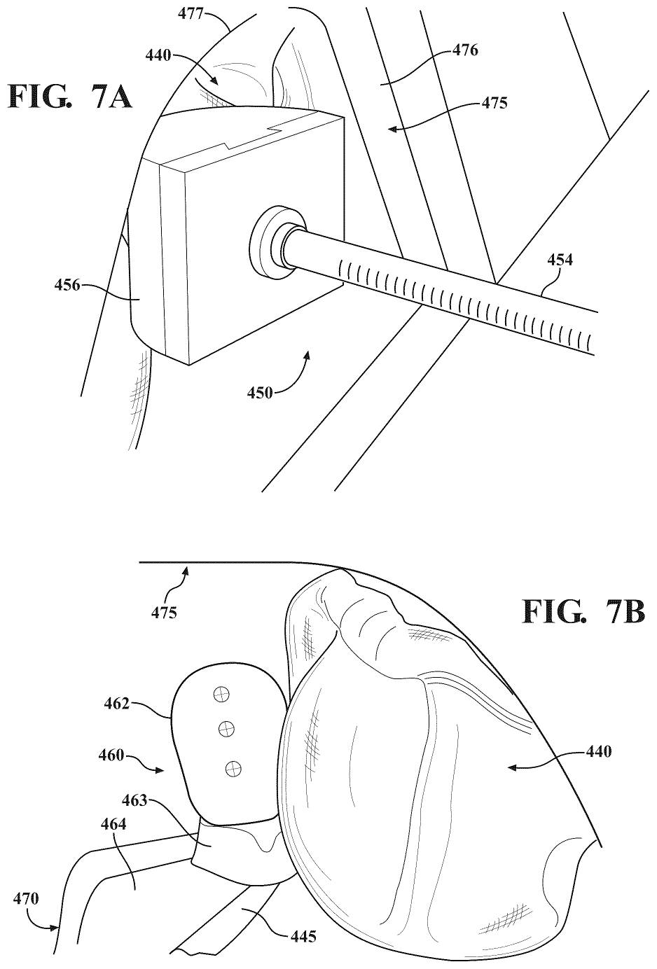

FIGS. 7A-7B show an example of the test at a second moment in time, which is subsequent to the first moment in time. At the second moment, the impactor 450 has come into contact with the airbag 440. FIG. 7A shows a view from an exterior of a vehicle body 475, and FIG. 7B shows a view from an interior of the vehicle body 475.

At the second moment in time, the end member 456 can pass through the window opening 477 and into contact with the airbag 440. The end member 456 can push the airbag 440 toward the interior of the vehicle body 475. The airbag 440 can push the head 462 (and possibly other portions) of the dummy 460 toward the interior of the vehicle body 475 (e.g., to the left in FIG. 7B). It will be appreciated that, when the inner surface 441 of the airbag 440 is not flat, it can cause a rotation of the head 462. Head data can be collected by the sensor(s) 430, including head rotation data.

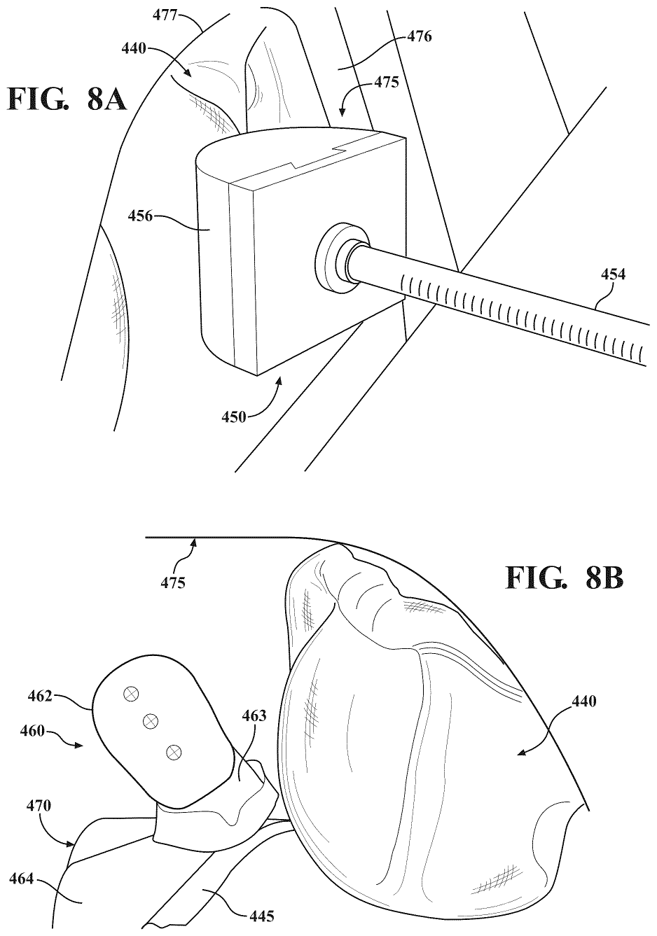

FIGS. 8A-8B show an example of the test at a third moment in time, which is subsequent to the second moment in time. At the third moment in time, the impactor 450 has contacted the airbag 440, showing a view from the exterior of the vehicle body 475. FIG. 8A shows a view from an exterior of a vehicle body, and FIG. 8B shows a view from an interior of the vehicle body 475. The end member 456 has retracted from the airbag 440. As a result, there is a spacing between the end member 456 and the airbag 440. The head 462 of the dummy 460 has continued to move toward the interior of the vehicle body 475 (e.g., to the left in FIG. 7B). Also, there may be rotation of the head 462. Head data can be collected by the sensor(s), including head rotation data.

The acquired sensor data can be used for various purposes. For instance, the acquired sensor data can be used to develop brain injury criteria and/or brain rotational injury criteria. The acquired sensor data can be used to test and develop new restraints, including airbag configurations and/or features. For instance, the acquired sensor data can be used to assess the configuration of an airbag, such as the location, size, shape, etc. of one or more chambers of the airbag. It will be appreciated that a large data set can be acquired and analyzed according to arrangements described herein because the vehicle body 475 is not crashed. Further, design changes to the airbag 440 and/or other restraints can be rapidly testing. Thus, facilitating the development of a design of the airbag and/or other restraint at least with respect to head, brain, and/or brain rotational injury criteria.

It will be appreciated that arrangements described herein can provide numerous benefits, including one or more of the benefits mentioned herein. For example, arrangements described herein can enable the collection of head and/or brain data or head and/or brain injury data. Arrangements described herein can do so without destroying a vehicle. Thus, arrangements described herein are readily repeatable and can provide cost savings over a vehicle test. Arrangements described herein can better correlate the angular rate of acceleration around the x-axis (passing through the front and back of the head (or passing through the front back of the vehicle)), the y-axis (passing through the right and left side of the head (or passing through the left and right side of the vehicle)), and/or the z-axis (straight up through the head (or passing through the top and bottom of the vehicle)) to standard crash testing. Arrangements described herein includes dummy and seat interaction, which is a better representation of the vehicle condition. Arrangements described herein avoid the need for using honeycomb or other structures to tune the energy absorbed by a head of a dummy.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
causing an impactor to be projected toward a head of a dummy at a target energy, a target position, and/or with a target stroke, the dummy being in a seated position on a vehicle seat, an airbag being located between the head and the impactor, the vehicle seat being substantially stationary.

2. The method of claim 1, wherein the airbag is a side curtain airbag.

3. The method of claim 1, further including:
causing the airbag to be deployed while the impactor is moving toward the head of the dummy.

4. The method of claim 1, wherein the airbag is deployed prior to causing the impactor to be projected at a head of a dummy.

5. The method of claim 1, further including:
acquiring sensor data relating to the dummy during and/or after engagement between the impactor and the airbag.

6. The method of claim 5, wherein the sensor data includes data about the head.

7. The method of claim 6, wherein the sensor data includes rotation data of the head.

8. The method of claim 1, wherein the impactor is aligned with the head of the dummy.

9. A system comprising:
a vehicle seat, the vehicle seat being substantially stationary;
a dummy seated in the vehicle seat, the dummy including a head and a body;
an impactor substantially aligned with the head, the impactor being configured to be projected toward the head; and
an airbag located between the dummy and the impactor.

10. The system of claim 9, wherein the airbag is a side curtain airbag.

11. The system of claim 9, further including one or more processors operatively connected to cause the airbag to be deployed while the impactor is projected toward the head.

12. The system of claim 9, wherein the airbag is deployed prior to the impactor being projected toward the head.

13. The system of claim 9, wherein the vehicle seat is substantially stationary.

14. The system of claim 9, further including one or more processors operatively connected to cause the impactor to be projected at the head at a target energy, a target position, and/or with a target stroke.

15. The system of claim 14, further including a vehicle body, and wherein the vehicle seat is located within the vehicle body, and wherein the vehicle body includes a window opening.

16. The system of claim 15, wherein the impactor is configured to pass through the window opening when projected at the head.

17. The system of claim 9, further including one or more sensors operatively positioned on the dummy, and wherein the one or more sensors are further configured to acquire sensor data relating to the dummy during and/or after engagement between the impactor and the airbag.

18. The system of claim 17, wherein the sensor data includes rotation data of the head.

19. The system of claim 9, further including one or more restraints operatively engaging the dummy to restrain the dummy on the vehicle seat.

20. The system of claim 9, wherein the impactor includes an end member, and wherein the end member is substantially semi-cylindrical.
